(19) United States
(12) Patent Application Publication
(10) Pub. No.: US 2019/0295163 A1
(43) Pub. Date: Sep. 26, 2019

(54) OPTIMIZED LOAN ASSESSMENT AND ASSISTANCE SYSTEM

(71) Applicants: John Zurick, Cincinnati, OH (US); Lee Latimer, Austin, TX (US); Matt Mantia, Austin, TX (US); Mike Foulk, Austin, TX (US); Sara Wilson, Austin, TX (US); Erica Delaney, Austin, TX (US)

(72) Inventors: John Zurick, Cincinnati, OH (US); Lee Latimer, Austin, TX (US); Matt Mantia, Austin, TX (US); Mike Foulk, Austin, TX (US); Sara Wilson, Austin, TX (US); Erica Delaney, Austin, TX (US)

(21) Appl. No.: 16/364,574

(22) Filed: Mar. 26, 2019

Related U.S. Application Data
(60) Provisional application No. 62/648,294, filed on Mar. 26, 2018.

(51) Int. Cl. G06Q 40/02; G06Q 30/00

(52) U.S. Cl. CPC G06Q 40/025; G06Q 30/016

(57) ABSTRACT

A system and method for assisting loan borrowers in assessing possible repayment options includes collecting borrower information and classifying borrowers according to campaign groups. Borrowers in each campaign group are contacted in a manner specifically designed for that campaign group to optimize the likelihood of generating a response from the borrower. A chatbot is used to generate a text or voice conversation with the borrower utilizing simple and short questions and answers to obtain information from the borrower and determine the borrower's eligibility for different repayment options. The chatbot then provides the borrower with a list of options which the borrower may select from. The system and method also includes providing a complete transcripts of the conversation to the borrower.

### CROSS-REFERENCE TO RELATED APPLICATIONS

This application claims priority to U.S. Provisional Application Ser. No. 62/648,294 filed on Mar. 26, 2018, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention

The present invention relates to a system and method for assessing one or more loans and assisting the borrower in evaluating repayment options. More particularly, the invention relates to an integrated system of software engines for identifying borrowers to be contacted, the best means for contacting particular borrowers and a chatbot optimized to accurately and correctly advise a borrower on possible repayment options in an efficient and positive manner, and facilitation of the borrower's action in the enrollment in the borrower's selected repayment plan(s).

### Description of the Related Art

Student loan debt, the number of loans, and the numbers of borrowers have grown exponentially in the new millennium. The amount of student loan debt ballooned from $260 billion in 2004 to over $1.4 trillion in 2017. In 2018 the number of borrowers grew to over 45 million owing over $1.5 trillion. The average debt per borrower upon graduation rose to over $37,000. Currently there is about $1.6 trillion in total Federal and private student loan debt.

Currently, 42 million borrowers are being served through FSA (Federal Student Aid) servicers and over 3 million are served through commercial and other lenders. The borrower base is projected to grow 40% by 2026. In 2018, 18 million new loans were assigned to servicers. Over 10 million were assigned between August and October alone.

Every year, about 18 million new college financial disbursements are originated, and 8 million Pell Grants are originated. About 35,000 other forms of aid (including TEACH Grants) are also generated annually. This results in about 53 million annual disbursements, 34 million from direct loans and 19 million from Pell Grants; and about 65,000 other forms of aid (including TEACH Grants).

All of these loans and other aid result in about 200 million payment transactions, 5 million re-certifications for income-driven repayment plans, 4 million loans closed (not including consolidation), 840,000 loans consolidated (average of five loans per borrower), 3 million repayment plan changes (impacting 16 million loans), 900,000 TEACH grant certifications, 420,000 PSLF certifications, 120,000 TPD certifications per year. Approximately 4 million loans are transferred from servicers to FSA's Debt Management and Collection System (DMCS) every month.

In addition to monetary transactions, borrowers generate a massive amount of inbound communications requiring a response. About 43 million loan accounts are accessed via the internet each month, 30 million via desktop and 12 million via mobile phones or tablets. An estimated 31 million inbound calls are received annually, averaging 7 minutes per call. About 4 million inbound physical mail items, 2 million inbound emails, and 431,000 customer complaints are also received annually.

Servicers generate about 575 million outbound emails annually, including 175 million collections related emails and 400 million non-collection related emails. Services also make about 309 million outbound calls annually, with about 282 million collections related and 27 million non-collection related. Services also send about 224 million physical mail items annually, about 61 million of which are collection notices, and 163 million are not related to collection.

Servicers and federally-certified schools are monitored by various agencies for compliance and accuracy. Approximately 500 program reviews are in process at any given time. 5,500 eligibility applications are processed annually, including 1,200 re-certifications, 2,100 acknowledgments and 2,200 additional oversight activities. Approximately 4,000 compliance audits are processed annually, 1,600 of which find deficiencies. 3,000 financial statements are processed annually, 950 of which are flagged for further review.

Servicers also process about 1,200 methods of payment packages annually, and about 7,000 student and/or school complaints are processed annually. Of these complaints, about 60 result in adverse actions initiated and about 60 FAD or FPRD appeals are processed. These result in about 10 debarment and/or suspension actions annually. These complaints also generate about 350 administrative action referrals, concurrences, preliminary evaluations, or extensive research completed every year.

The higher education industry that serves these loans and their borrowers has been unable to scale up their service capacities to meet these ballooning demands for debt management and borrower support. A linear, reluctant approach to innovation has saddled the student loan service industry with an outmoded call center dependency that is now the epicenter of higher ED financing dysfunction. Currently, the aggregate student loan servicing industry would require about 5,000 competent call center agents, speaking with borrowers 70 hours a week/52 weeks a year to meet the current demand for live-agent talk-time service. These call centers manage about 35 million outgoing connected borrower calls triggered by 309 million outgoing robocalls, 31 million inbound connected calls, which in total require 148,077 hours/wk. of competent agent talk-time.

Unfortunately, inefficiency permeates the call centers across the entire industry plaguing it with problems in hiring, training, management, burnout, equipment, workspace, human error, administrative overhead, etc. Common failures in the system include not presenting borrowers all of their repayment options and miscalculating what borrowers should have to pay across their selection of income-driven repayment (IDR) plans. Borrowers are commonly and repeatedly placed in costly forbearance plans without offering them more beneficial options.

Finding the right repayment option can make a huge difference in repayment outcomes for customers. However, customers struggle to find information about and understand the 30+ repayment options (e.g., different plans like IDR, deferment, consolidation, forgiveness, etc.), due to challenges navigating existing information sources and understanding numerous option requirements. This impedes the customer's ability to choose the right option or combination of options.

Customers struggle to understand and fulfill repayment application and re-certification requirements, leading to delays, re-work, and possible exclusion from their best options. Many applications are rejected due to customer error, driven by manual application processes/forms. Limited insight into processing timing or status prevents customers from resolving issues quickly.

Customers struggle to understand the cumulative impact of what they have borrowed, how interest accrues and capitalizes, how their payments evolve over time, how their payments are calculated, and what progress they've made on repaying their loans. They may disagree with their payment amounts and balance, either due to limited understanding (e.g., of impact of forbearance on interest accrued) or actual servicer human error.

Customers struggle to identify who to pay, when to pay, and how to pay. They may struggle to sign up for auto-debit or experience errors in its execution. They may be unable to request specific overpayment allocation without calling or mailing their desired allocation, which too often leads to frustration, errors, or processing delays.

Customers in delinquency/default have high dissatisfaction, and may experience meaningful negative consequences; every effort should be made to assist them in avoiding delinquency/default. However, they struggle to understand their options (e.g., IDR, consolidation, rehabilitation) and report having limited information about or how to pursue them. They often have not been proactively contacted about their situation and receive limited or generic support as they try to cure.

Customers often go months without their issue being resolved, and they have limited methods of knowing where their requests are in the process. Customers must navigate multiple accounts, redundant sign-in steps, and challenging log-in and reset processes between both FSA and servicer websites. For some key customer tasks (e.g., applications), customers may need to jump between multiple sites, different accounts, and authentication steps, creating barriers to access and customer frustration.

Customers rely on communications from servicers to understand key deadlines, information, and actions they need to take. However, customers struggle to understand the communications they receive due to generic and/or dense language, limited clarity around expectations or next steps, and challenges receiving or accessing communications due to the channel of distribution or outdated customer information (e.g., incorrect address).

Customers should be able to expect one version of the truth, no matter the channel or servicer. However, today customers struggle to reconcile the information they receive, as different channels and sources may have inconsistent information due to differences in policy interpretation, inconsistencies with Customer Service Representative (CSR) understanding or information access (e.g., due to lack of tools and resources and/or inadequate visibility into customer circumstances).

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide an improved method of advising student loan borrowers of their options for managing and paying their student loan debts.

### BRIEF SUMMARY OF THE INVENTION

Disclosed is an improved system for assisting loan borrowers that is faster, easier, and simpler than existing programs. It provides better answers and solution options, and an improved end-to-end experience, with fewer call agents and less call agent time required. The platform is available 24 hours a day, 7 days a week, 365 days a year. The system is unaffected by human error or servicer revenue interests, it increases servicer efficiency, slashes the costs of call agents recruiting, hiring, training, oversight, equipment, facilities, payroll/benefits, and turnover. It also eliminates human errors in borrower counseling, data collection, and reporting, while easily scaling up to borrower service volume and servicer income in step with market growth, at a fraction of the cost of call center expansion.

The system and method do this digitally, by connecting data from multiple sources and configuring a set of available and proprietary tools to identify the target community of borrowers, analyze each borrower's individual needs, execute outbound communication campaigns, and deliver counseling content in the borrower's best interests by drawing from, and in full compliance with, the federal student loan regulations and principles. Expected users include federal student loan servicers, private banks, credit unions and financial institutions, postsecondary institutions, and third-party default prevention servicers.

It is therefore an object of the present invention to provide improved borrower servicer efficacy; faster, easier, simpler and better answers and solution options; improved end-to-end experience using fewer or no call center agents; increased servicer efficiency through reduced costs of call center agent recruiting, hiring, training, oversight, equipment, facilities, payroll/benefits, and turnover, elimination of human errors in borrower counseling, data collection, reporting, and scaling up borrower service capacity and servicer income in step with market growth, at a fraction of the cost of call center expansion.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 a flowchart of a method for using predictive engines and a chatbot to advise a borrower on possible repayment options in accordance with the principles of the invention;

FIG. 2 is a flowchart of a method for advising grace borrowers on possible repayment options in accordance with the principles of the invention;

FIG. 3 is a flowchart of an exemplary method for introducing a chatbot to a borrower and verifying a borrower's information in accordance with the principles of the invention;

FIG. 4 is a flowchart of an exemplary method for counseling a borrower on possible repayment options in accordance with principles of the invention;

FIG. 5 is a flowchart of an exemplary method for counseling a borrowing possible repayment options accordance with principles of the invention;

FIG. 6 is a flowchart of an exemplary method for verifying and updating a borrower's contact information in accordance with principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Natural language processing (“NLP”) is a sub-field of artificial intelligence that is focused on enabling computers to understand and process human languages, to get computers closer to a human-level understanding of language. The Counseling Dialog Rules include a series of if/then statements and other rules that regulate conversations created using a chatbot or similar program or platform.

The present invention provides a platform for connecting data from multiple sources and configuring a set of available and proprietary tools to identify the target community of borrowers, analyze each borrower's individual needs, execute outbound communication campaigns, and deliver counseling content. Expected users include federal student loan servicers, private banks, credit unions and financial institutions, postsecondary education institutions and third-party default prevention servicers. The platform of the invention connects with borrowers using a proprietary chatbot, the rules for which are developed in compliance with standing Department of Education and Federal Student Aid borrower terms, conditions, responsibilities, guidelines, options and overlaid with a conversational tone of positivity and support for borrowers, free of any bias for borrower solutions that would have been in compliance with ED rules but put servicer interests over borrower interests.

Disclosed is a system and method with the following steps:

a. Identifying borrowers for outreach using a risk-scoring algorithm. b. Determining the optimum method of contacting borrowers. c. Introducing borrower to a chatbot by sending outreach communications to the borrower customized to the borrower's campaign group and likely preferred communication medium. d. Allowing borrowers to engage chatbot through a choice of available channels. e. Providing counseling to the borrower. f. Reminding borrowers of, and their progress through, necessary follow up actions.

Step a: Identify borrowers for outreach using risk-scoring algorithm. Borrowers are identified and targeted based on available user data from available data sources. First, data regarding borrowers is collected from sources such as federal/state government agencies, loan servicers, schools and loan holding institutions. The data acquired includes demographic information such as age, location, gender, school(s) attended, major, status (withdrawn, graduated), performance (credits, grades, etc.), and credential(s) achieved (certificate, Associate's, Bachelor's, Master's, etc.). In addition, information regarding borrowers' loans are also acquired, such as current loan(s) status (current, delinquent, etc.), balance(s), payment amount(s), repayment plan(s), payment due date(s), grace period, and specific loan servicer(s). All of the borrowers and their respective information is compiled in a system database.

Next, Borrowers are selected from the collected data by applying risk scoring and assigning borrowers to campaign groups. A risk scoring algorithm is used to apply a risk score to borrower, which drives time, frequency, method and message for outreach. In one exemplary embodiment, the risk assessing tool Foresight® created by Loan Science is used. Foresight® is purpose-built for federal and private student loans and applies proven quantitative methods to identify trends, segment risks, build predictive models and forecast performance.

Step b: Determine the optimum method of contacting borrowers. The user data is analyzed by the system and used to determine the best time, frequency and method to contact borrowers, the best type of messaging, and the best method for providing counseling for borrowers in each campaign group. Data collected from all borrowers within a campaign group, including the history of interactions and the outcomes of other counseling sessions, is also used to determine the most effective method of contacting a borrower in order to maximize the likelihood of obtaining a response from the borrower. The methods for counseling borrowers are usually selected from text messaging, an internet website, and a telephone call.

Step c: Introduce borrower to a chatbot by sending outreach communications to the borrower customized to the borrower's campaign group. Communications may be built using software, for example OneLook® by Loan Science, that provides communication templates specific to each campaign group. Communications may include one or more of SMS text messages, emails and telephone calls. Communications are optimized using the data for each campaign group to increase the rate of response from targeted borrowers. Targeted borrowers are invited to use a chatbot through outbound email and SMS text campaigns. Targeted borrowers also may be invited or made aware of the chatbot through marketing and promotion of the tool by their school, loan servicer, as well as on voice messages left for the targeted borrowers selected to receive an outbound phone call either instead of, or in addition to the above-mentioned outreach methods. In one embodiment, a borrower receives an email and/or SMS text invite to message a chatbot. The message provided to the borrower includes borrower-specific linked keys and instructions on how to start a chat session.

Step d: Allow borrowers to engage chatbot in conversation through choice of available channels including web chat, SMS text or voice call. The method in accordance with the principles of the invention allows borrowers to select a method of communicating with the chatbot. A borrower may select one or more of responding affirmatively to SMS text invitation, sending nine-digit access code via SMS text to a designated toll-free number, entering a chat from website, entering a mobile number on website and selecting to receive SMS text, and calling a designated toll-free number. Upon entering a chat, recognized borrowers receive a welcome and begin ID verification. An unrecognized borrower is transferred to a live agent for assistance.

When a borrower chooses to initiate a chat session, the chatbot first authenticates the user by querying a linked key tied to a borrower record stored in the system database of borrowers. Once the identity of the borrower is confirmed, the chatbot is governed by a set of counseling dialog rules. The counseling dialog rules are applied using NLP and voice recognition tools that together form a verbal user interface. The verbal user interface allows the chatbot and the borrower to have a conversation through SMS/text, web, and/or telephony integration. Throughout the conversation with the borrower, additional user information is collected by the chatbot and stored in the system database along with the borrower's other user data.

In one exemplary embodiment, Twilio Autopilot® serves as the NLP engine and provides programmable SMS text, programmable voice and programmable chat features for use with the chatbot of the invention. The Counseling Dialog Rules in accordance with the principles of the invention are housed within Twilio's® runtime functions and govern the conversation between the chatbot and a borrower.

Step e: Provide counseling to a borrower. The counseling provided by the chatbot is based on the Counseling Dialog Rules Engine, user data collected from the system database, and new user data collected in real time during the counseling session. The chatbot of the invention uses data from the system database to refine a model conversation dialogue to provide counseling to the borrower that best meets the borrower's needs. The chatbot advises the borrower of available repayment options, and records and transmits the borrower's preferences and/or selections, all in real time with no processing delays. A borrower's immediate needs are identified through a series of questions posed by the chatbot and answered by the borrower. The chatbot provides guidance and assistance to help resolve any issues the borrower may have meeting his or her current repayment obligations. The chatbot updates borrower contact information, provides loan balance and payment information, offers assistance to users having difficulty repaying, and guides a borrower to his or her best option to meet his/her situation. This includes obtaining information from the borrower which is used to determine what options are available to reduce or delay monthly payments and evaluating whether the borrower qualifies for loan forgiveness or other options.

In addition, a complete record of quantitative and qualitative data exchanged during the chatbot conversation is maintained in the servicer record. An anonymized record of the service is used to further improve the model conversations used by the chatbot. This information is immediately integrated with all subsequent predictive analytics used in the delivery of the best, individualized borrower service. An exemplary sequence of a counseling conversation between a chatbot and a borrower includes:

ID verification. An underlying linked key ties the borrower's specific data to the borrower engaging with the chatbot through one of the available interaction channels. The chatbot welcomes the borrower using only his/her first name. Before any non-public information is shared, the borrower confirms his/her identity by providing either a date of birth or the last 4 numbers of his/her SSN.

Loan information. Once the borrower's identity is confirmed, the chatbot will query the system database for available loan information. The chatbot uses Counseling Dialog Rules and available loan information to share with the borrower details such as: his/her loan status, loan balance, current monthly payment amount, current repayment plan, payment due date, loan servicer name and contact information.

Assess where assistance is needed. The chatbot asks borrower if he/she is able to meet the repayment obligations of his/her loan, while also assuring the borrower that assistance options, including non-payment options, may be available. If no assistance is needed, the chatbot moves to confirming and updating contact information.

Provide assistance. If assistance is needed, the chatbot uses the Counseling Dialog Rules to ask follow up questions and narrow down to the best possible solution to resolve the borrower's problem. The conversation concludes with a mutual agreement to the action the borrower and/or servicer will take to document and initiate whatever they agreed is the best plan for the borrower.

Confirm contact info. Before the session ends, the chatbot requests to confirm the borrower's contact information by querying the borrower records in either the system database, presenting the borrower with a primary address, email address and phone number. For each item, the borrower is asked if this is the best contact information. If the borrower answers “no” to any item, he/she is asked to provide new information. The information is collected and stored in the system database.

Step f. Remind borrower of necessary follow up actions. The borrower is sent a detailed follow up message to recap the discussion and provide clear next steps with links/attachments to any additional forms necessary to complete the action. An exemplary follow up message is an email containing the details of the conversation with the chatbot and directions on any remaining necessary steps to complete in order to achieve the desired result agreed upon during the conversation. Examples include, but are not limited to changing repayment plans, requesting deferment or requesting forbearance. To complete these types of requests, the borrower is provided a pre-filled PDF application based on answers provided during the chatbot conversation along with instructions to review the information for accuracy. If accurate, borrower can sign the application and submit it, as well as any necessary documentation, per instructions provided in the email. A transcript of the conversation with the chatbot is available to the borrower at the conclusion of all conversations.

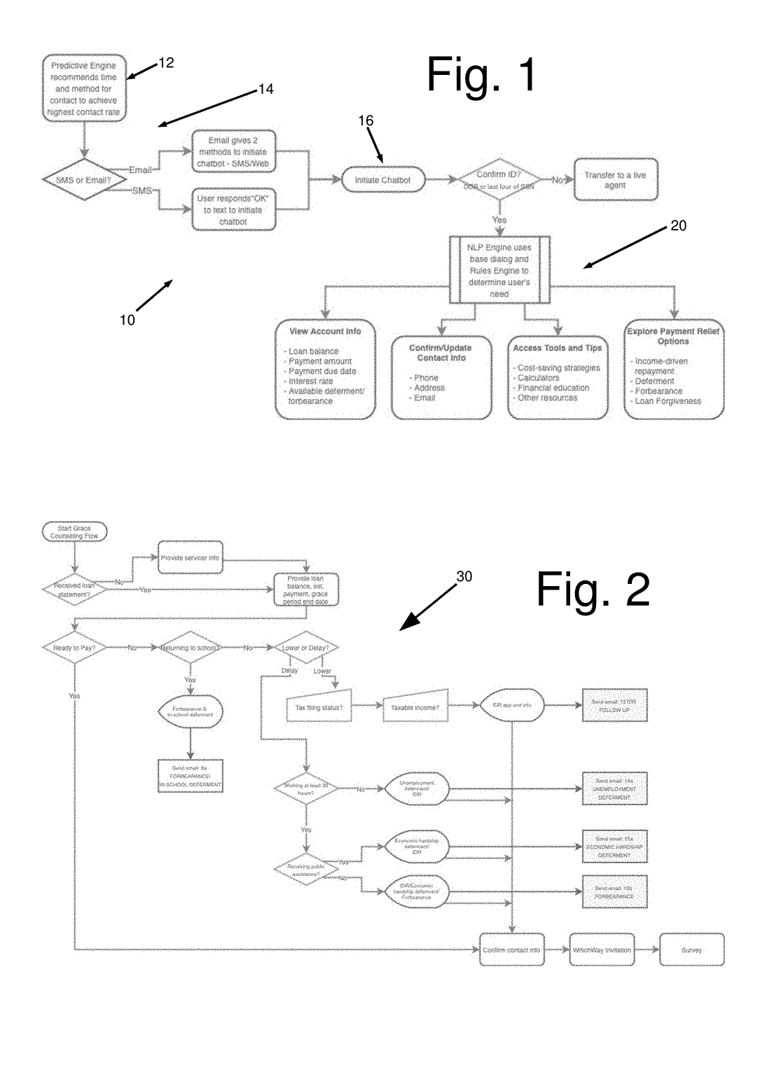

FIG. 1 shows a flowchart 10 summarizing the above-described method. The first box 12 shows step a, where borrowers are categorized into different campaign groups using a predictive engine. In step b, shown in region 14 of the flowchart, the system determines the optimal method for contacting borrowers in a particular campaign group. The method continues to steps c and d in region 16 where the borrower is introduced to the chatbot and engages the chatbot using one or more channels. The final region 20 of the flowchart 10 shows the multiple functions performed in step e of the method as described above, where the chat bot provides a variety of information to the borrower, confirms and/or updates contact information and assist the borrower in evaluating the different options available to him or her and selecting the best of those options.

### Example 1 Grace Borrowers

“Grace borrowers” are borrowers who are usually recent graduates or recent drop-outs who have not yet exhibited any indications that they will likely have difficulty repaying their student loans. They are typically a low priority to loan servicers who tend to reserve their overloaded service capacity for borrowers who are in some degree of repayment risk or are proactively reaching out to the servicer for help. In at least some embodiments of the present invention, Grace borrowers are specifically targeted as a campaign group likely to positively engage with the method of the present invention, including the chatbot.

An initial launch was conducted over a 10-day period. 4,786 borrowers, 10-45 days from the end of their Grace Period, were selected. The selection of Grace borrowers in this campaign group was random with regard to servicer, as well as from the standpoint for school, loan amount, geography, age, and other factors that could have slanted the borrower needs or the service outcomes.

A series of emails and SMS text messages were sent over 10 days to the grace borrower campaign group population, inviting each borrower to interact with a chatbot voice named “Lume.” In this example, email and SMS invitations were sent providing borrowers several ways to interact with the chatbot. Two emails were generated and two SMS text messages were generated and sent to the grace borrowers:

Email #1—4,767 recipients

SMS #1—4,705 recipients

Email #2—4,699 recipients

SMS #2—4,515 recipients

The grace-specific predictive engine assessed the borrower's situation, determined if the borrower needs repayment assistance, and then presented to the borrower his/her best options. FIG. 2 shows a flowchart 30 of a typical chatbot conversation conducted with a grace borrower. The information was transmitted back to the borrower over the selected user interface platform. 375 borrowers (7.84% contact rate) responded within first 15 days. In comparison, outbound live agent phone campaigns over the last 6 months resulted in 3.65% contact rate. Response breakdown:

Website>Text me now—108 borrowers

Website>Call me—14 borrowers

SMS response to invite—250 borrowers

Code sent to SMS—3 borrowers

The user experience is as follows:

ID verification—211 borrowers (58.45%) successfully verified their identity

Date of birth—206 borrowers

Last 4 of the SSN—5 borrowers

2 borrowers opted to transfer to a live agent instead of continuing with the chatbot

Loan information provided: The borrower was asked if he/she has received a billing statement from his/her loan servicer. If yes, the borrower was reminded of his/her est. monthly payment, grace period end date, and first payment due date. If no, the borrower was given his/her servicer name and info. Then told his/her est. monthly payment, grace period end date, and first payment due date.

Assess where assistance is needed: The borrower was asked if he/she was ready to start making these payments each month, and reassured if not, assistance may be available. If no assistance was needed, the chatbot confirmed he/she knew how to submit payments and then confirmed contact information.

Provided assistance: The chatbot assessed which option was best to meet the borrower's goals given his/her specific situation. 120 borrowers indicated a need for lowering or delaying their monthly payment.

The chatbot asked if the grace borrower was returning to school. 52 grace borrowers were presented with information and direction on obtaining In-School Deferment.

The chatbot asked if the grace borrower needed to lower his/her monthly payment. 41 borrowers were presented with information and direction on obtaining Income-Driven Repayment (IDR).

The chatbot asked if the grace borrower was working less than 30 hours per week. 12 borrowers were presented with information and direction on obtaining an Unemployment Deferment.

The chatbot asked if the grace borrower was receiving public assistance. 3 borrowers were presented with information and direction on obtaining an Economic Hardship Deferment.

The chatbot asked if the grace borrower needed to delay/defer payment for any other reason. 12 borrowers were presented with information and direction on exploring IDR, economic hardship deferment, and forbearance.

The chatbot confirmed contact information. All borrowers were asked to confirm or update their contact information. 70 borrowers provided updates to phone, address and/or email address.

In this example, the grace borrowers were able to carry on a conversation with the chatbot via SMS text. Alternative options include web-based chat and voice calls.

| | | Present Invention |
|---|---|---|
| | | Initial Results |
| | Standard Phone Model | Email and SMS |
| | Email followed up with | messages with option to |
| | varying frequency of | transfer to a live agent |
| | phone calls; all | phone call; majority of |
| | counseling provided by | counseling provided by |
| Grace Borrower Program | live agent | chatbot |
| Email Interactions | | |
| Open Rates | 4.64% | 5.63% |
| Clicks | 2.39% | 11.66% |
| Phone/Chat Interactions | | |
| Connect Rate | 3.65% | 7.84% |
| Right Party Contact (ID Verified) | 15.89% | 60.00% |
| Repayment Relief Requested | 39.67% | 56.87% |
| Projected Needs to Service 1,000 Borrowers | | |
| Required Human Capital (in hours) | 116.67 | 9.33 |

Follow up actions. All borrowers indicating a need for repayment assistance receive a follow up email with additional detail, instructions and all necessary applications (links/attachments). In addition, all borrowers were provided a transcript of the chatbot conversation for their records.

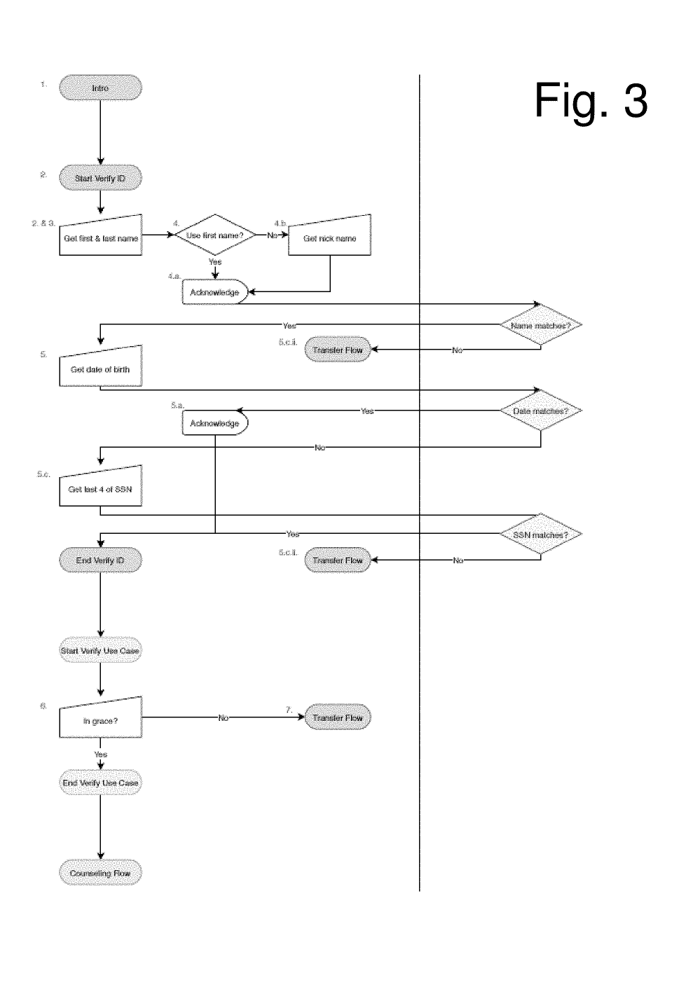

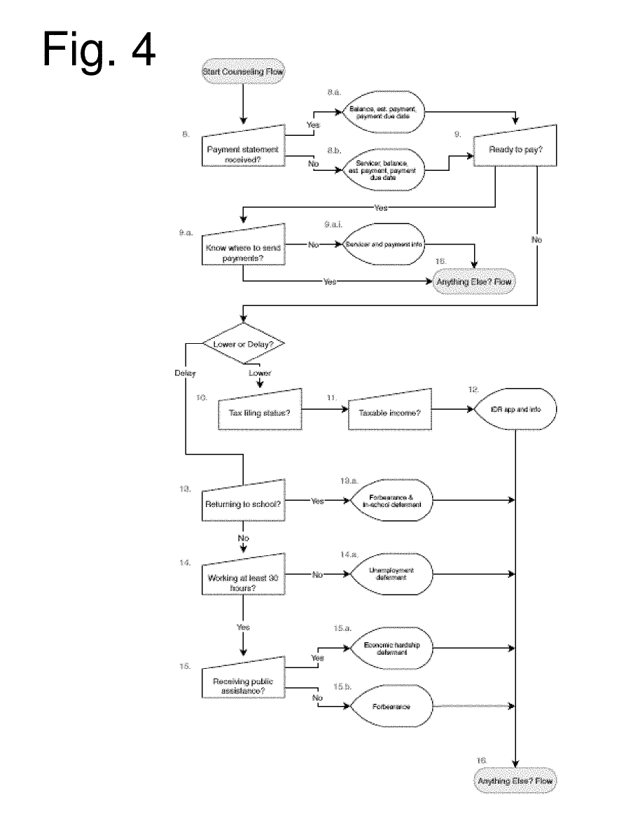

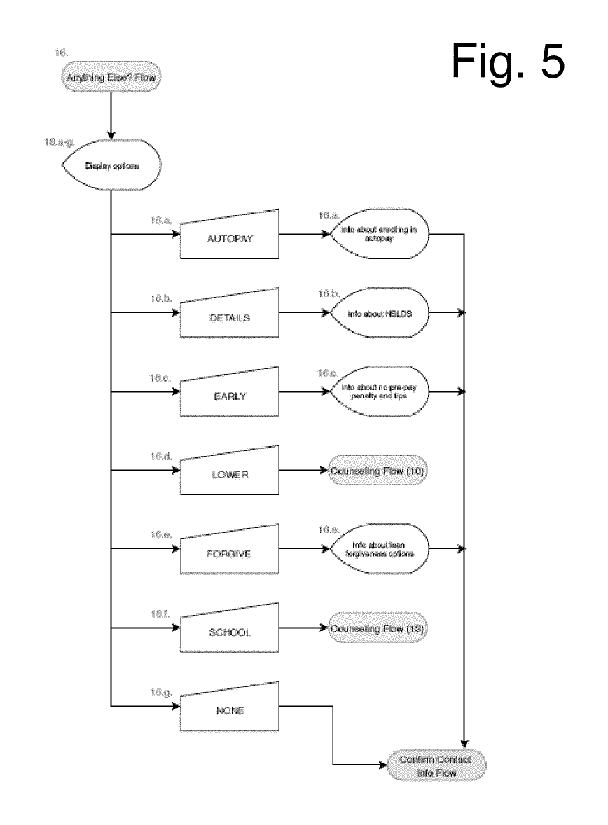

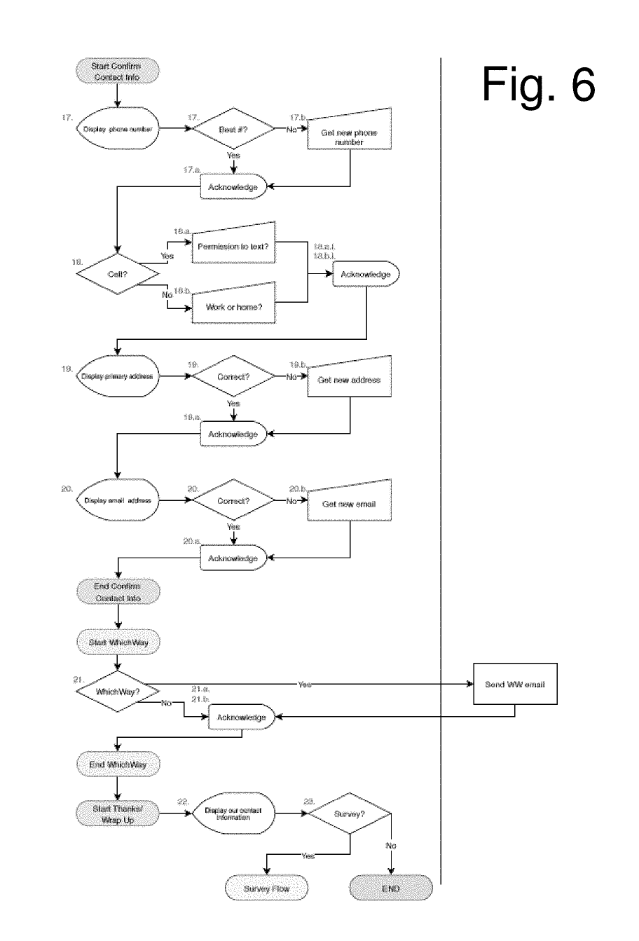

FIG. 3 shows exemplary chatbot conversation rules for initiating a conversation with a borrower. These rules are fairly straightforward as they are only intended to confirm the identity of the borrower. A chatbot in accordance with the principles of the invention may also introduce itself with a name selected by the loan servicer or other entity practicing the invention. Even though the borrower understands that it is a chatbot, this nonetheless improves a borrower's attitude and experience during the interaction. FIGS. 4 and 5 are exemplary flowcharts of conversation rules for generating a chatbot conversation with a borrower assessing the borrowers need and eligibility for various options. While these flowcharts appear fairly straightforward, they are particularly designed in a manner that simplifies the conversation into short questions requiring short answers while also obtaining all of the information necessary to assess a borrower's eligibility for a wide variety of delay, deferment and forgiveness programs. The rules illustrated in these flowcharts generate a conversation with a borrower that is easy for the borrower to follow and understand and also results in reliable, accurate and consistent results in providing correct information to a borrower so that he or she may select the best available option for repayment. FIG. 6 shows exemplary conversation rules for verifying and/or updating a borrower's contact information.

In the above example of utilizing borrower risk assessment, optimized method of contacting a borrower, and a chatbot of a method in accordance with the principles of the invention demonstrated a substantial improvement over standard prior art methods of engaging borrowers. In addition, the method in accordance with the principles of the invention was accomplished without the use of a call center and engaged borrowers prior to late payments and/or defaults. As a result, borrowers are engaged in an efficient manner that prevents difficulties for borrowers before they arise. The positive experience further increases the likelihood that borrowers will continue to engage with the same chatbot in the future. Without being bound by theory, the inventors believe that borrowers are more receptive to a chatbot because they are more accustomed to communicating in relatively short, simple answers and questions via text or Robo call. It is also believed that borrowers actually prefer a chatbot to a human being because software programming is considered unbiased and immune to human error. This explains why borrowers are more likely to engage and interact with a chatbot. The present invention also provides a written transcript, usually as a PDF file sent via email, of the chatbot conversation for the borrower's records and convenience. This allows the borrower to verify that he or she correctly answered all the questions posed.

In addition, properly evaluating whether a particular borrower qualifies for any of the multitude of loan repayment delay, deferment and forgiveness programs is complicated and arduous. This type of analysis is extremely difficult to perform reliably and accurately using live calling agents in a call center. Call centers have notoriously high turnover rates and due to the relatively low pay, has substantial difficulty attracting agents capable of reliably and accurately assisting borrowers and correctly determining their eligibility for various programs. For this reason, many loan servicers do not bother engaging grace borrowers, but instead focus on borrowers who already exhibit several risk factors and are already experiencing difficulty in repaying their loans. The present invention allows loan servicers to identify and assist at risk borrowers before difficulties have arisen, which can often complicate and/or hinder a borrower's ability to obtain assistance such as delay, deferment and forgiveness. The invention therefore provides a substantially greater quality of service at a substantially reduced cost and a tiny fraction of man-hours otherwise required. The invention also creates trust with the borrowers contacted by providing a positive experience.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A method for assisting loan borrowers in selecting a loan repayment option comprising the steps of:
a) identifying borrowers for outreach using a risk-scoring algorithm, and assigning borrowers to a campaign group;
b) determining the optimum method of contacting borrowers;
c) introducing borrower to a chatbot by sending outreach communications to the borrower customized to the borrower's campaign group and likely preferred communication medium;
d) allowing borrowers to engage chatbot through a choice of available channels;
e) providing counseling to the borrower; and,
f) reminding borrowers of, and their progress through, necessary follow up actions.
